(19) United States
(12) Patent Application Publication
(10) Pub. No.: US 2023/0116479 A1
(43) Pub. Date: Apr. 13, 2023

(54) HAZARDOUS WASTE DISPOSAL SYSTEM AND METHOD

(71) Applicant: Hazmat Reduction System Inc., Bellevue, WA (US)

(72) Inventor: Michael G. McGrann, Washougal, WA (US)

(21) Appl. No.: 17/962,109

(22) Filed: Oct. 7, 2022

Related U.S. Application Data
(60) Provisional application No. 63/255,171, filed on Oct. 13, 2021.

(51) Int. Cl. C02F 9/00; B01D 29/90; B01D 29/35; B01D 29/94; B01D 37/03; B01D 1/30; B01D 36/00

(52) U.S. Cl. CPC C02F 9/00; B01D 29/90; B01D 29/35; B01D 29/94; B01D 37/03; B01D 1/30; B01D 36/003; B01D 2201/48; B01D 2201/265; B01D 1/0041

(57) ABSTRACT

A system for the disposal of liquid waste includes a portable container body having an open interior and a liquid waste inlet for receiving liquid waste containing solids. A liquid waste holding tank is provided within the open interior of the portable container body for receiving the liquid waste from the liquid waste inlet. A liquid-solid separator within the open interior of the portable container body produces a solid waste and a separated liquid waste. A conduit directs the liquid waste from the liquid waste holding tank to the liquid-solid separator. An evaporator within the open interior of the portable container body heats the separated liquid waste to evaporate and remove water from the separated liquid waste as water vapor and produces a concentrated liquid waste. A safety containment system prevents the liquid waste from escaping to the environment. A method for disposing of liquid waste is also disclosed.

### CROSS-REFERENCE TO RELATED APPLICATIONS

This application claims priority to U.S. Provisional Patent Application No. 63/255,171 filed on Oct. 13, 2021, entitled “Hazardous WASTE DISPOSAL SYSTEM AND METHOD”, the entire disclosure of which is incorporated herein by reference.

### FIELD OF THE INVENTION

The present invention relates to waste disposal, and more particularly to the disposal of liquid waste containing toxic suspended or dissolved substances.

### BACKGROUND OF THE INVENTION

The disposal of liquid waste containing toxic suspended or dissolved substances requires the handling of large volumes and weights of liquid. Although all toxic waste can be treated with the system of the present invention wood treatment will be used as an example. In the case of wood treatment facility, for example, the treated wood liquid is classified as a dangerous waste. It is classified as a dangerous waste due to the toxicity associated with metals, primarily chromium, copper, and arsenic, tebuconazoles, with a second waste stream showing trace amounts of lead, barium, silver, and mercury. The liquid is not classified as corrosive, and has an anticipated pH range of between 3-9.8 The waste is not considered to be ignitable or reactive. The waste does contain a high percentage of suspended solids. The proper storage and disposal of large amounts of such liquid waste is time consuming and costly.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a perspective view of a liquid waste disposal system according to the invention.

FIG. 2 is a schematic cross-section of a liquid waste disposal system according to the invention.

FIG. 3 is an enlarged schematic cross-section of area 3 in FIG. 2.

FIG. 4 is an enlarged schematic cross-section of area 4 in FIG. 2.

FIG. 5 is an enlarged schematic cross-section of area 5 in FIG. 2.

FIG. 6 is an enlarged schematic cross-section of area 6 in FIG. 2.

FIG. 7 is a top plan view, broken away to show interior features.

FIG. 8 is a side elevation, broken away to show interior features.

FIG. 9 is an enlarged schematic cross-section of area 3 in FIG. 2, in a first mode of operation.

FIG. 10A is enlarged schematic cross-section of area 10A in FIG. 9, in a first mode of operation; FIG. 10B is enlarged schematic cross-section of area 10A in FIG. 9, in a second mode of operation; FIG. 10C is an enlarged cross-section of area 10A in FIG. 9, in a third mode of operation; FIG. 10D is an enlarged cross-section of area 10A in FIG. 9, in a fourth mode of operation.

FIG. 11 is an enlarged schematic cross-section of area 11 in FIG. 2.

### DETAILED DESCRIPTION OF THE INVENTION

A system for the disposal of liquid waste includes a portable container body having an open interior and a liquid waste inlet for receiving liquid waste containing solids. A liquid waste holding tank is provided within the open interior of the portable body for receiving the liquid waste from the liquid waste inlet. A liquid-solid separator within the open interior of the portable body produces a solid waste and a separated liquid waste. A solid waste removal system is provided for receiving the solid waste and placing the solid waste into disposal containers. A conduit directs the liquid waste from the liquid waste holding tank to the liquid-solid separator. An evaporator within the open interior of the portable body heats the separated liquid waste to evaporate and remove water from the separated liquid waste as water vapor, which can be at 0.001 Parts Per Million and can produce a minor residual amount of concentrated liquid waste.

A safety containment system can be provided for retaining overflow or leakage from escaping from the portable body. The safety containment system can include a primary containment apparatus such as a containment liner positioned under the system components. The containment liner has a floor portion and upwardly extending side portions so as to form a container for catching and retaining overflow and spillage. All components of the system can be positioned over the containment liner such that all liquid waste from the system will be captured. The safety containment system can include secondary safety containment apparatus such as a catchment container under the floor of the portable container body. An overflow conduit from the containment liner to the catchment container can be provided. The overflow conduit has an inlet distanced above the floor of the liner such that when liquid waste in the containment liner or primary containment system or apparatus reaches the height of the inlet the liquid waste will flow to the catchment container. The safety containment system can also include a tertiary safety containment apparatus as a berm container positioned under the portable body. The portable container body can be positioned over the tertiary container for additional protection in the event of small drips and overflows, for example during transfer of material to and from the portable container body. The tertiary berm container is positioned at or near the ground and has a liquid waste-impermeable floor and peripheral upwardly extending side portions to catch any liquid waste which might escape from the container body and/or primary and secondary containment systems. This tertiary berm container acts as the final defense in case the other containments systems fail.

The liquid-solid separator can be a screw press assembly. One of several manufacturers offer solutions based on the type of chemical makeup the portable containment body will be used for. Many types of liquid-solid separators are possible, such as filtration devices.

A flocculant treatment station can be provided for adding a flocculant to the liquid waste. The flocculant helps to agglomerate the solids in the liquid waste and to help the separation from the liquid. Many flocculants are known, and include polyacrylamides, chitosan and aluminum compounds such as aluminum sulfate, aluminum chloride and sodium aluminate.

The portable body can be part of or attached to a truck or other electric, fuel cell or combustion engine vehicle capable of moving the portable body. It is also possible to move the portable body by means of another mobile device such as a boat or a barge. The portable body can be a trailer having wheels and an attachment system for attaching the trailer to a motor vehicle. Other vehicles are possible, for example, the system can be provided in a portable container body such as a standard shipping container or a container similarly dimensioned, and then secured to a flatbed truck or other vehicle.

A method for the disposal of liquid waste includes the step of directing a vehicle having a portable container body that can have a liquid waste inlet for receiving liquid waste containing solids to a site with the liquid waste. The liquid waste is transferred into a liquid waste holding tank for receiving the liquid waste from the liquid waste inlet. The liquid waste is transferred from the liquid waste holding tank to a liquid-solid separator. The liquid-solid separator produces a solid waste and a separated liquid waste. The separated liquid waste is transferred to an evaporator and heated to evaporate and remove water from the separated liquid waste as water vapor and to produce a minor residual amount of concentrated liquid waste.

The method can include providing a safety containment system for retaining liquid waste overflow or leakage. A double lined inlet hose can extend from the customers holding tank to the main liquid waste holding tank of the invention. Liquid waste overflow or leakage can be retained by a primary safety containment apparatus such as a liner for the vehicle body. Overflow from the primary safety containment apparatus can be retained by a secondary safety containment apparatus, such as a catchment container positioned beneath the portable container body. The liquid waste overflow or leakage can be collected by a tertiary safety containment apparatus, such as a berm positioned underneath the vehicle, trailer, or other mobile system.

The system and method of the invention have particular utility for the disposal of liquid waste from environmental hazardous waste treatment facilities. These facilities generate large amounts of liquid wastewater containing metals, primarily chromium, copper, and arsenic, and also sometimes trace amounts of lead, barium, silver, and mercury. The metals will remain in the concentrated liquid of the evaporator. The water that is evaporated from the evaporator can be vented to the atmosphere without the risk of environmental contamination to 0.001 microns PPM lower than the current standard in the industry of 0.010 PPM. Also, the system components can be operated at or near atmospheric pressure, so risks associated with elevated pressures are reduced or eliminated.

The operating conditions of the system can vary. Typically, the system works in an ambient temperature. The only temperature variation from ambient is the introduction of the liquid stream is at the evaporation chamber. That temperature will be 213 to 220 degrees Fahrenheit. All plumbing pressures will be maximum rated at 250 PSI and typical operating pressures not to exceed 150 PSI. Flue gas from the evaporator will not exceed manufacturers safety parameters. All systems will be PLC controlled for additional protection. The system can be operated as a batch system or a continuous system.

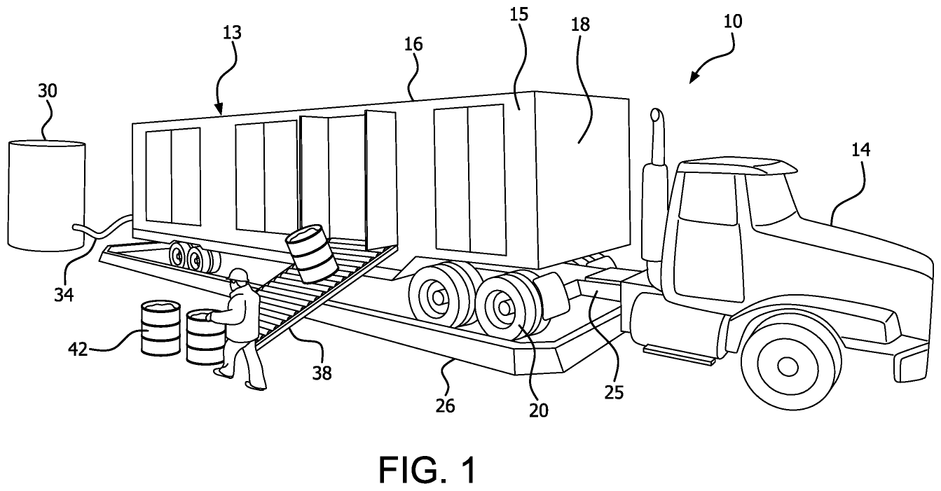

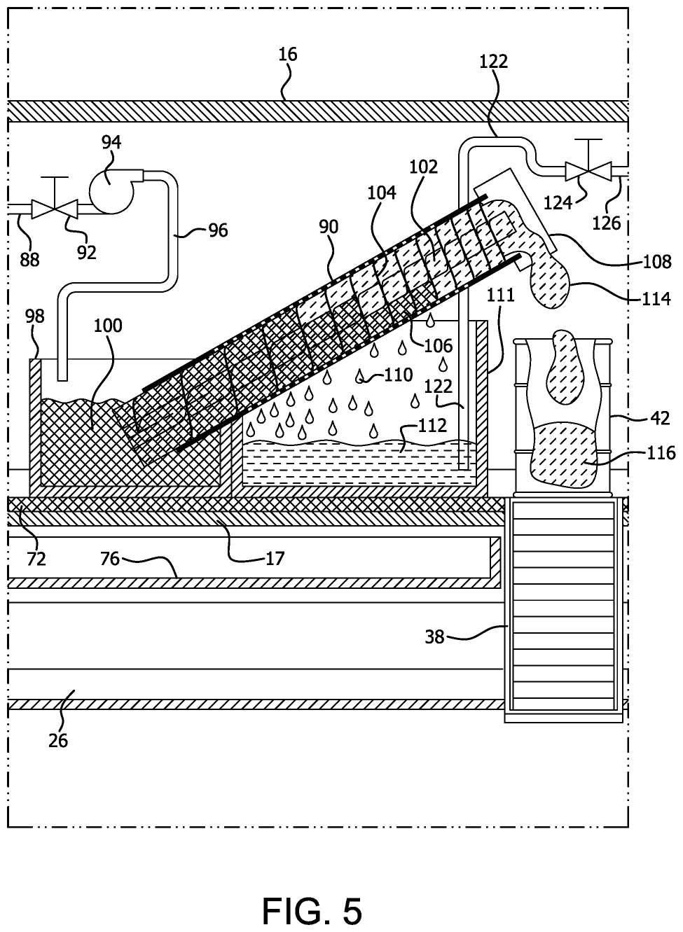

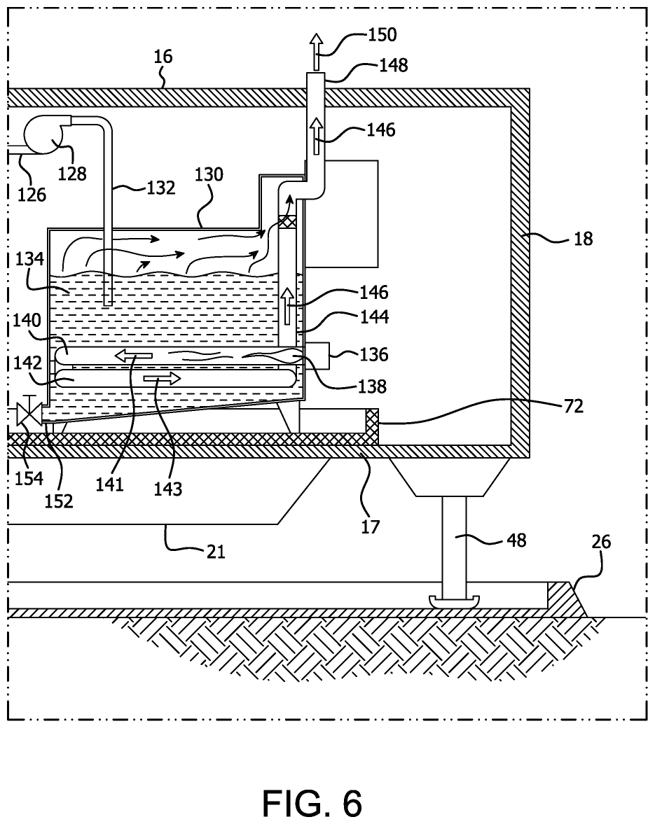

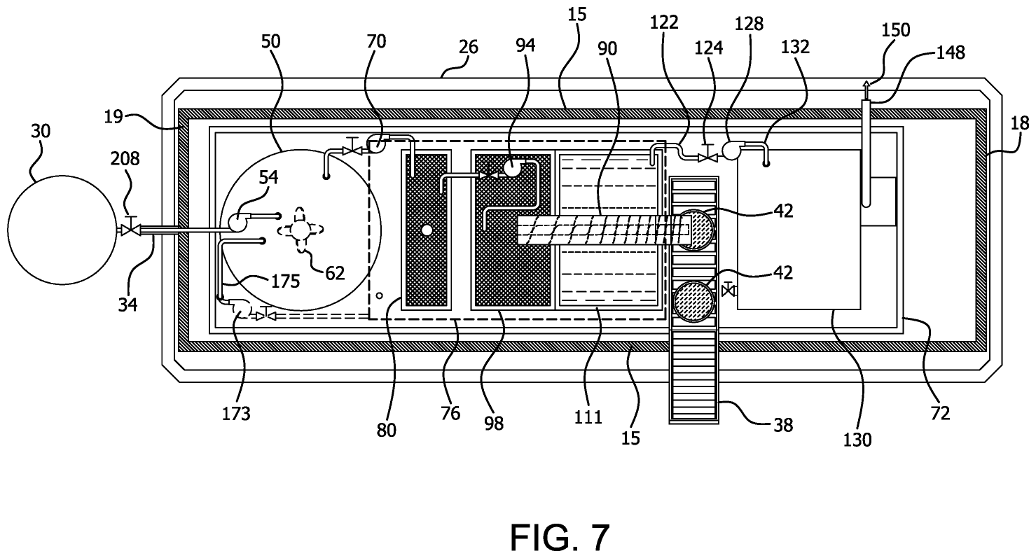

There is shown in FIGS. 1-11 a liquid waste disposal system and method. As shown in FIG. 1, the system 10 can be portable and mobile through truck 14 operable to pull a trailer having a portable container body 13 with side walls 15, top 16, bottom 17, front wall 18 and rear wall 19. The portable container body 13 is mounted on a suitable trailer support 18 connected to wheels 20. The truck 14 can have a rear framework 25 with a fifth wheel suitable for connecting to the trailer. The trailer when disconnected from the truck 14 can rest on extendable/removable support 48.

A tertiary berm containment system 26 is provided for the catchment of liquid waste from overflow and drippings as will be described. A client waste storage container 30 has liquid waste to be treated. A liquid waste transfer conduit 34 is provided to transfer liquid waste to the system 10. A ramp 38 or other suitable structure can be provided for lifting barrels 42 into the portable container body 13 to receive solid sludge or removing the barrels 42 from the portable container body, or barrels 42 that can contain concentrated liquid waste. The ramp 38 can be retractable or removable. Electric, mechanical or pneumatic lifting structure is also possible to lift and lower the barrels 42.

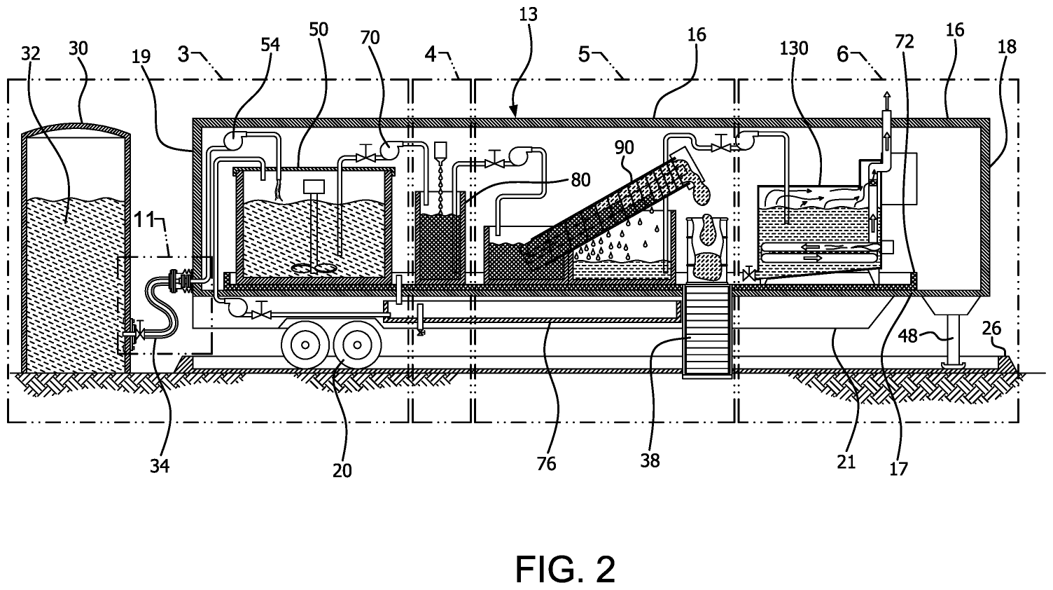

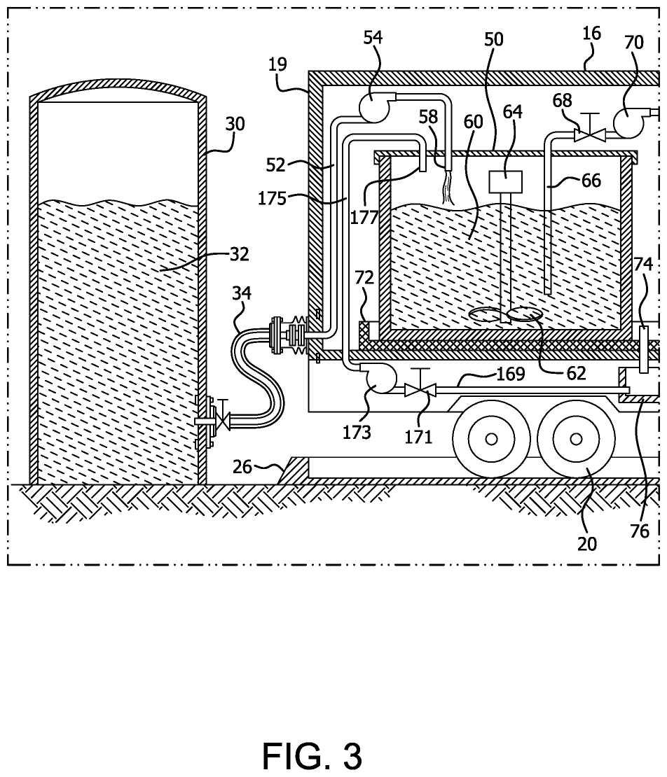

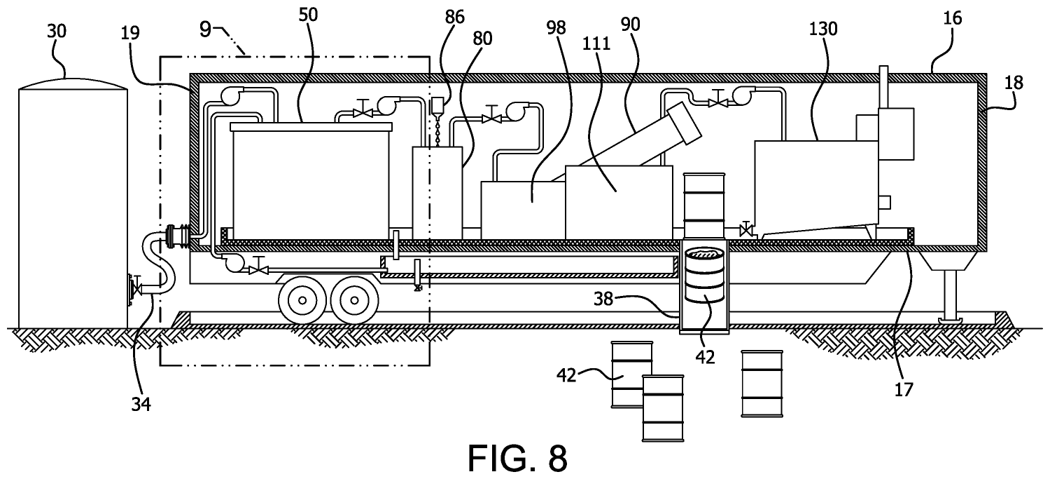

There is shown in FIGS. 2-8 a system in the portable container body which includes a liquid waste holding tank 50, a flocculant treatment station 80, a screw press 90, and an evaporator 130 (FIG. 8). As shown in FIG. 3, liquid waste 32 from the customer facility container 30 is transported by conduit 34 to the portable container body 13 through an inlet conduit 52 which transfers the liquid waste through the action of suitable pump 54 and liquid waste inlet 58 into a liquid waste holding tank 50. The liquid waste 60 accumulates in the holding tank 50 and can be agitated by suitable means such as agitation blades 62 driven by motor 64 to keep suit suspended solids in suspension. On demand, the liquid waste 60 in the holding tank 50 is removed through outlet conduit 66 controlled by valve 68 and the action of pump 70.

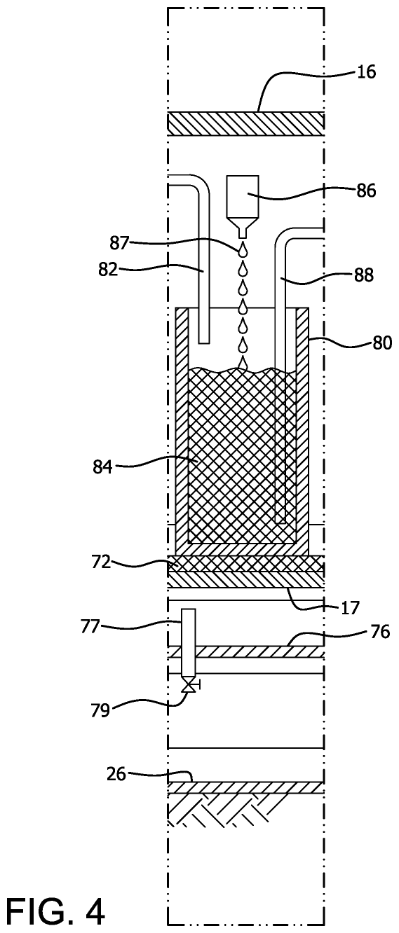

As shown in FIG. 4, flocculant treatment container 80 has an inlet conduit 82 communicating with pump 70 and thereby receives liquid waste 84 from the holding tank 50. The flocculant is added from a flocculant source 86 and the flocculant 87 is directed to the liquid waste 84 in the flocculant treatment container 80. Liquid waste 84 treated with flocculant is removed through conduit 88 and controlled by valve 92 and the action of suitable pump 94 to direct the liquid waste to a liquid-solid separator such as screw press 90.

A screw press inlet conduit 96 directs the liquid waste that has been treated with the flocculant into a suitable screw press inlet storage container 98. Liquid waste 100 accumulates in the screw press inlet storage container 98 and is drawn into the screw press 90 by the action of shaft 102 driving screw blades 104.

The action of the screw press 90 is to remove liquid droplets 110 through suitable openings 106 in the screw press 90. The liquid effluent 112 from the screw press 90 is collected in a screw press storage outlet container 111. The accumulated liquid effluent 112 is removed from the screw press storage outlet container 111 through an outlet conduit 122 communicating with a valve 124 and through a connecting conduit 126 to a suitable pump 128. Solid waste 114 leaving the outlet 108 of the screw press 90 is deposited as collected solid waste 116 into disposal barrels 42.

Liquid effluent from the screw press 90 is directed through evaporator inlet conduit 132 into an evaporator 130 and accumulates as evaporator liquid 134. The evaporator liquid 134 is heated by a suitable heat source such as a burner 136 creating heated gas 138. The heated gas 138 travels through suitable heat transfer conduit such as pipes 140 and 142 as indicated by arrows 141 and 143. The generated water vapor and heated gas exhaust can be exhausted through an exhaust conduit 144 as shown by arrows 146 and escapes through a vent 148 as shown by arrow 150. When the evaporation process has been completed in a batch process, or in a continuous process, the minor residual amounts of concentrated liquid 134 can be removed from the evaporator through an outlet 152 controlled by valve 154. The concentrated liquid 134 can then be directed through a suitable conduit (not shown) to collection containers for proper disposal.

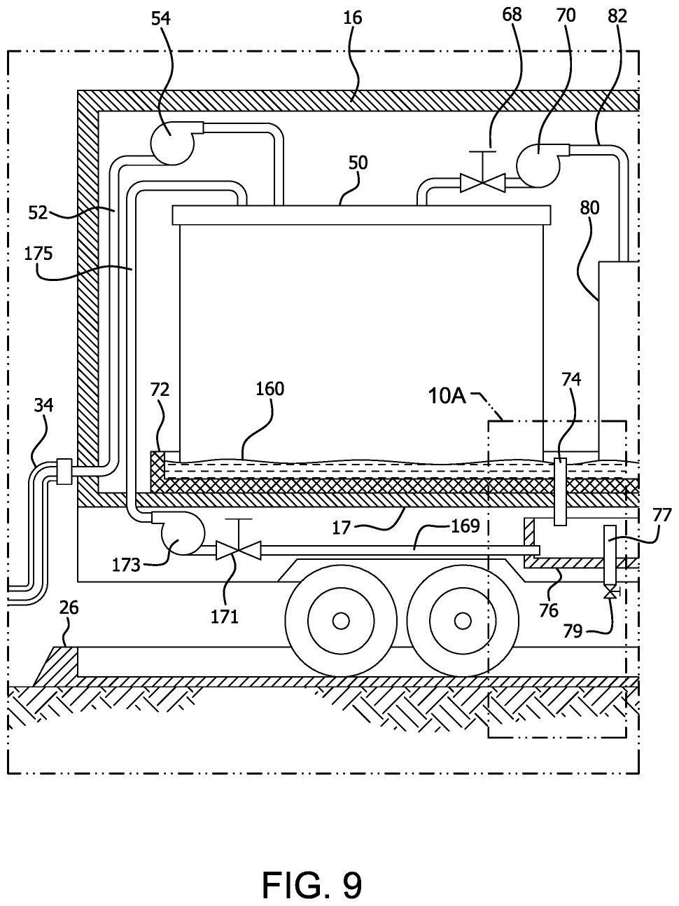

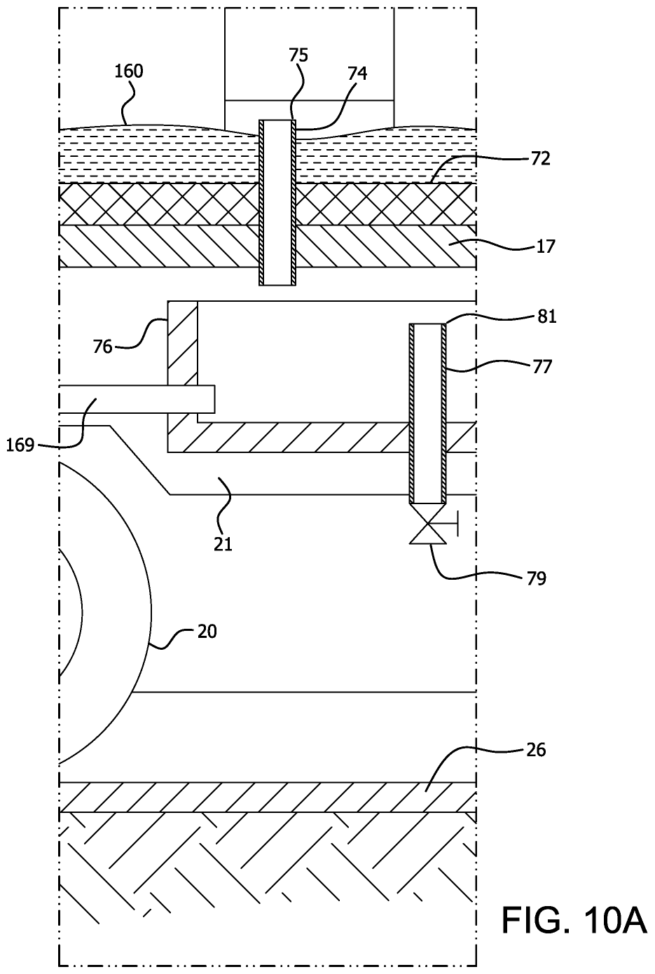

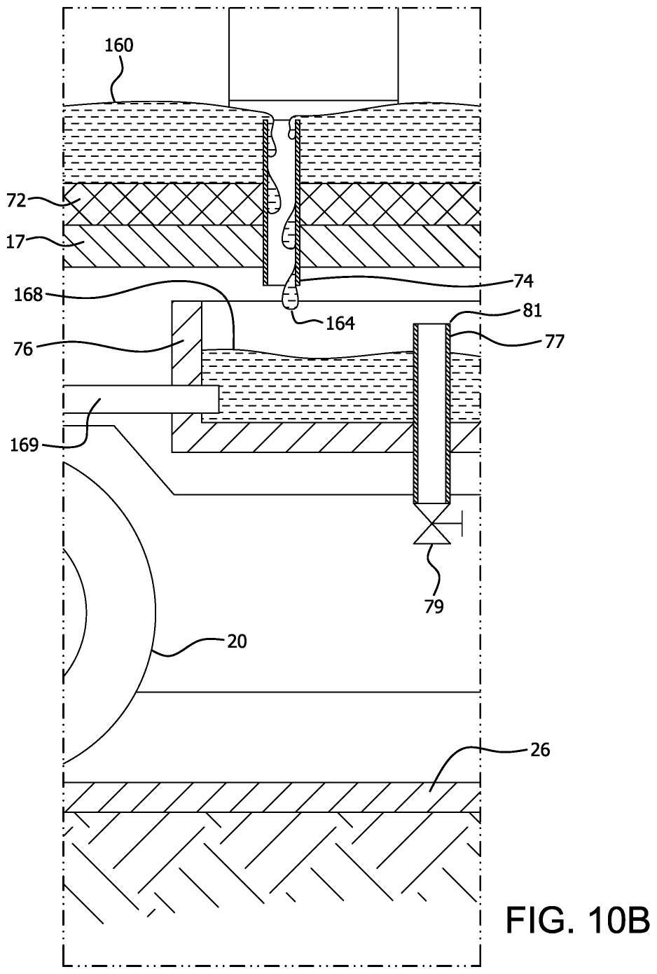

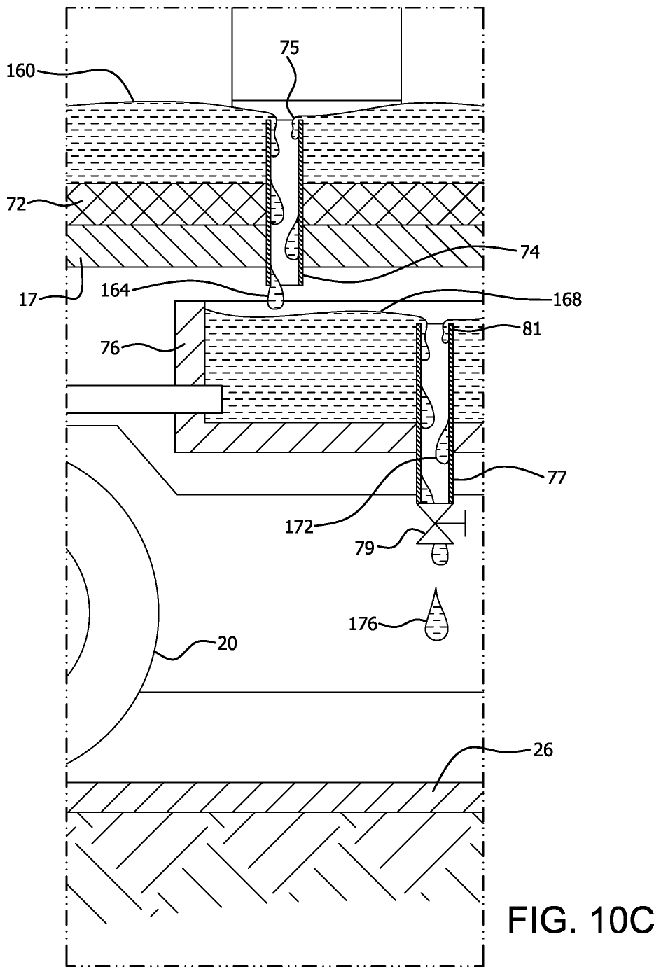

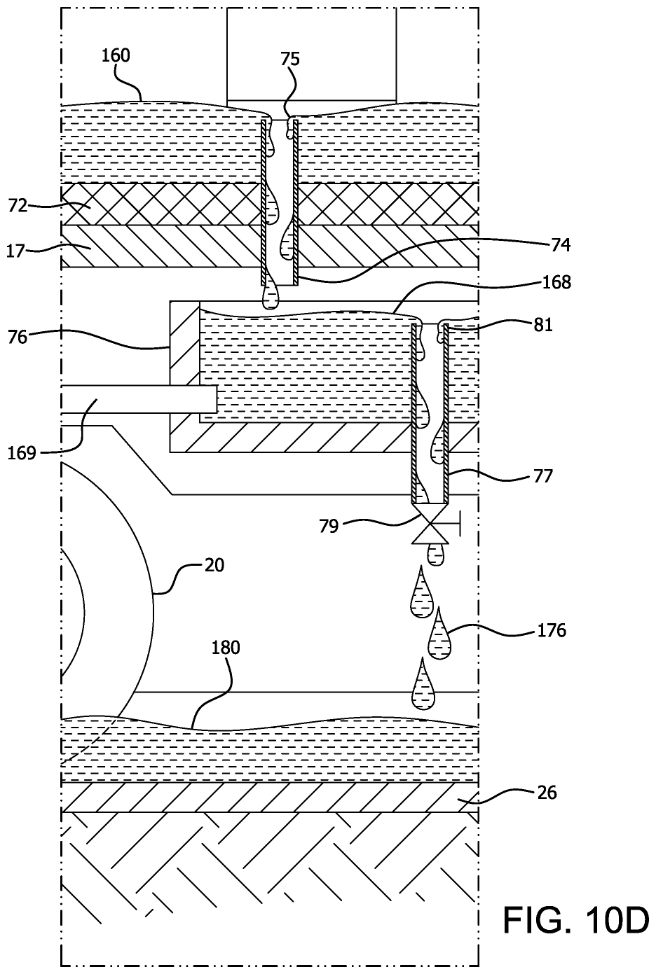

As the liquid waste contains toxic substances, control of spillage is essential. A primary containment system such as containment liner 72 (FIG. 9) can be provided in the portable container body 13 and accumulates initial overflow, leakage or spillage 160. An overflow pipe 74 is active when the spillage 160 reaches the level of the inlet 75 of the overflow pipe 74. This inlet can be approximately 2″ inches below the top level of the containment wall from the surface of the containment liner 72, although other positioning is possible. As shown in FIG. 10B, the overflow liquid 160 then flows as an overflow stream 164 through the overflow pipe 74 into a secondary containment system such as catchment container 76 under the trailer 18. This excess liquid spillage 168 will accumulate in the catchment container 76. It can be pumped through return conduit 169 controlled by valve 171 and pump 173 to a holding tank return conduit 175 and holding tank return inlet 177 into the holding tank 50.

An excess overflow outlet 77 can be provided in the catchment container 76. The inlet 81 of the overflow outlet 77 can be positioned approximately 2 inches below the top level of the containment wall from the surface of the catchment container 76, such that when the liquid reaches this height it will flow into the overflow outlet 77. When the excess liquid spillage 168 reaches the height of the inlet 81 of the excess overflow outlet 77 it will travel as an excess liquid waste stream 172. A valve 79 can be provided to permit the escape of this excess liquid into a suitable disposal container (not shown) as an excess liquid disposal stream 176. Any additional leakage or spillage 180 which falls from the system will be collected within the berm container 26 under the trailer 18 as shown in FIG. 10D. The height of the berm 26 can be approximately 14 inches although other heights are possible depending on the size and design of the system.

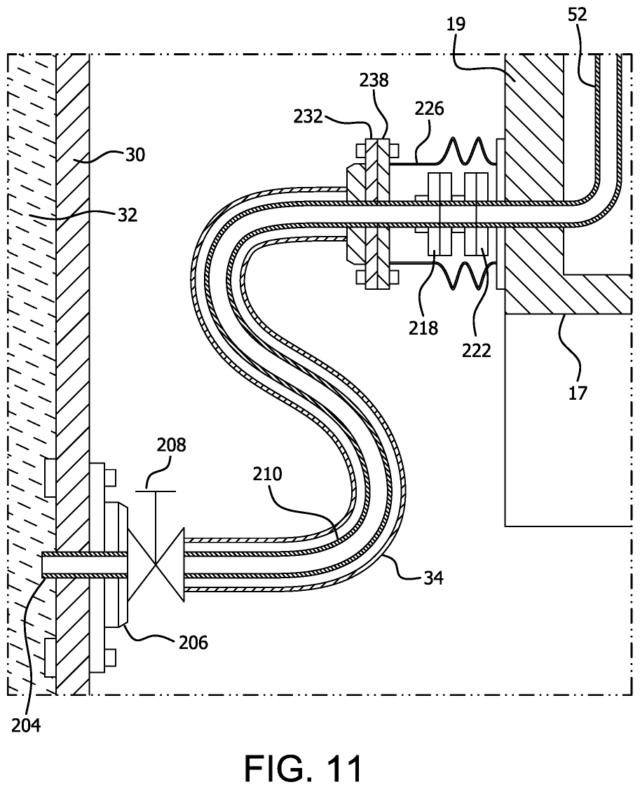

Additional leak protection can be provided by securing the transfer of liquid from the customer container 32 the trailer 16. An outlet 204 from the customer container 30 can communicate with a valve 208 through a connecting bracket 206 (FIG. 11). The transfer conduit 34 is connected to the valve 208 and to the portable container body 13. The transfer conduit 34 is double-walled and an inner conduit 210 is provided for the transfer of the toxic waste to the system 10. The outer conduit 34 is provided to catch any leakage or spillage from the inner transfer conduit 210. The conduit 34 can be connected to the rear wall 19 of the portable container body 13 through the action of suitable connection brackets 218 and 222, which connect the inner conduit 210 to the inlet conduit 52. A bellows 226 secured to the rear wall 19 can be provided to catch any liquid waste which escapes through this connection. The bellows 226 can be connected to the conduit 34 through the operation of suitable brackets 232 and 238.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A system for the disposal of liquid waste, comprising:
a portable container body having an open interior and a liquid waste inlet for receiving liquid waste containing solids;
a liquid waste holding tank within the open interior of the portable container body for receiving the liquid waste from the liquid waste inlet;
a liquid-solid separator within the open interior of the portable container body for producing a solid waste and a separated liquid waste;
a conduit for directing the liquid waste from the liquid waste holding tank to the liquid-solid separator;
a solid waste removal system for receiving the solid waste and placing the solid waste into disposal containers;
an evaporator within the open interior of the portable container body for heating the separated liquid waste to evaporate and remove water from the separated liquid waste as water vapor and producing a concentrated liquid waste;
a conduit for conveying the separated liquid waste from the liquid-solid separator to the evaporator;
a safety containment system for retaining overflow or leakage from escaping form the portable body.

2. The system of claim 1, wherein the liquid-solid separator comprises a screw press assembly.

3. The system of claim 1, further comprising a flocculent treatment system for adding flocculant to the liquid waste prior to the liquid-solid separator.

4. The system of claim 1, wherein the safety containment system comprises a primary safety containment liner in the portable container body positioned under the holding tank, solid-liquid separator and evaporator.

5. The system of claim 4, wherein the safety containment system comprises a secondary containment catchment container below the portable container body.

6. The system of claim 5, further comprising an overflow conduit from the primary safety containment liner to the secondary safety containment catchment tank.

7. The system of claim 1, wherein the safety containment system further comprises a tertiary containment berm container under the portable container body.

8. The system of claim 1, wherein the portable container body is part of a truck.

9. The system of claim 1, wherein the portable container body is a trailer having wheels and an attachment system for attaching the trailer to a motor vehicle.

10. A method for the disposal of liquid waste, comprising the steps of:
directing a vehicle having a portable container body having a liquid waste inlet for receiving liquid waste containing solids to a site with liquid waste;
transferring the liquid waste into a liquid waste holding tank for receiving the liquid waste from the liquid waste inlet;
transferring the liquid waste from the liquid waste holding tank to a liquid-solid separator, the liquid solid separator producing a solid waste and a separated liquid waste;
transferring the separated liquid waste to an evaporator and heating the separated liquid waste to evaporate and remove water from the separated liquid waste as water vapor and producing a concentrated liquid waste.

11. The method of claim 10, further comprising providing a safety containment system for retaining liquid waste overflow or leakage.

12. The method of claim 11, wherein the liquid waste overflow or leakage is retained by a containment liner for the portable container body.

13. The method of claim 11, wherein the liquid waste overflow or leakage is retained by a catchment container attached to and beneath the portable container body.

14. The method of claim 11, wherein the liquid waste overflow or leakage is collected by a berm container positioned underneath the portable container body.
